(19) United States
(12) Patent Application Publication
(10) Pub. No.: US 2019/0319880 A1
(43) Pub. Date: Oct. 17, 2019

(54) SOFTWARE DEFINED NETWORK AND METHOD FOR OPERATING THE SAME

(71) Applicant: NEC Laboratories Europe GmbH, Heidelberg (DE)

(72) Inventors: Fabian Schneider, Darmstadt (DE); Alessio Silvestro, Bologna (IT); Thomas Dietz, Weingarten (DE)

(21) Appl. No.: 16/471,052

(22) PCT Filed: Dec. 22, 2016
(86) PCT No.: PCT/EP2016/082333

§ 371 Date: Jun. 19, 2019

(51) Int. Cl. H04L 12/721; H04L 12/727; H04L 12/755; H04L 12/715

(52) U.S. Cl. CPC H04L 45/38; H04L 45/64; H04L 45/021; H04L 45/121

(57) ABSTRACT

A method operates a software defined network that has a number of data plane elements having flow table entries that define forwarding functions of the data plane elements; and at least one control plane element for programming the forwarding functions of the data plane elements by instructing the data plane elements to install appropriate flow table entries. The method includes: obtaining, by the data plane elements, flow table entry installation time information and making this information available directly or indirectly to the at least one control plane element; and using, by the at least one control plane element, the flow table entry installation time information for deciding on which of the data plane elements to install a particular flow table entry and/or when to transmit an instruction to one or more of the data plane elements to install a particular flow table entry.

### CROSS-REFERENCE TO PRIOR APPLICATIONS

This application is a U.S. National Stage Application under 35 U.S.C. § 371 of International Application No. PCT/EP2016/082333 filed on Dec. 22, 2016. The International Application was published in English on Jun. 28, 2018, as WO 2018/113967 A1 under PCT Article 21(2).

### FIELD

The present invention relates to a software defined network and a method for operating such software defined network.

### BACKGROUND

Software-defined networks (SDN) are characterized by having their control plane decoupled from the data plane. In particular this means that the network elements' forwarding functions (data plane) are programmed by a network controller (control plane). Popular approaches to implement SDN therefore expose a programming interface to add, modify, and delete entries in the flow tables of network elements, such as switches, routers or the like. These flow table entries are used to determine where to forward traffic and what processing steps are applied to the traffic before forwarding it.

Current research highlights the variance of flow table entry (FTE) installation times in a given switch. Reasons for this variance include (i) current number of flow entries installed, (ii) number of flow entries that are in queue to be installed, (iii) automatic data structure re-organization schedules, (iv) type of FTE and which flow table(s) is(are) used for the installation of the FTE as well as (v) overall load of the switch (for reference, see Roberto Bifulco and Anton Matsiuk: “Towards Scalable SDN Switches: Enabling Faster Flow Table Entries Installation”, in Proceedings of the 2015 ACM Conference on Special Interest Group on Data Communication (SIGCOMM '15), ACM, New York, N.Y., USA, 343-344).

Kuźniar et al. (for reference, see M. Kuźniar, P. Perešíni, D. Kostić: “What you need to know about sdn flow tables”, in Proceedings International Conference on Passive and Active Network Measurement (PAM'15), pages 347-359) have summarized and extended prior work regarding performance characteristics of flow table updates in three hardware switches, classifying previously known and newly-identified causes of unexpectedly long flow table update times. Even identical switches receiving identical FTE updates will have different update times depending on memory usage and consolidation of overlapping rules. This could lead to inefficiencies in planning and deployment of new traffic flows and even (temporary) incomplete paths.

Dudycz et al. (for reference, see S. Dudycz, A. Ludwig, S. Schmid: “Can't touch this: Consistent network updates for multiple policies”, in Proc. 46th IEEE/IFIP International Conference on Dependable Systems and Networks (DSN), 2016) noted the impact on critical services, including data center infrastructure, and reference the state-of-the-art workaround which is to update a route by means of iterative “rounds”, each subset of switches being chosen and updated such that, independently of the (unpredictable) times and order in which the updates of this round take effect, the route remains intact and the network is always consistent. The intent of Dudycz et al was to improve this algorithm to handle simultaneous multiple route updates, and define loop-free update algorithms for multiple policies in SDNs, such that the number of switch interactions is minimized’, however they proved the problem to be ‘NP-hard, already for two routing policies’ and instead derived an ‘efficient, polynomial-time algorithm that, given correct update schedules for individual policies, computes an optimal global schedule with minimal touches.’ That work did not attempt, however, to optimize the total time required for the re-routing, relying on “safe rounds” to preclude mis-routing.

Förster et al. (for reference, see Klaus-Tycho Förster and Roger Wattenhofer: “The Power of Two in Consistent Network Updates: Hard Loop Freedom, Easy Flow Migration”, inProc. 25th International Conference on Computer Communication and Networks (ICCCN), 2016) emphasize the negatives of mis-routing (large losses of data, increases in latency, temporary overloading of links) and derive re-routing algorithms for splittable flows. However they also assume that due to unpredictable timing of updates ‘it is not possible to control the order in which the nodes contained in an update U change from old to new.’

Ludwig et al. (for reference, see A. Ludwig, J. Marcinkowski, S. Schmid: “Scheduling Loop-free Network Updates: It's Good to Relax!”, in Proceedings of the 2015 ACM Symposium on Principles of Distributed Computing (PODC '15), ACM, New York, N.Y., USA, 13-22) relaxed the constraint of never allowing loops, allowing temporary loops which are not on the transient main path, however they also do not consider FTE times.

El-Hassany et al (for reference, see A. El-Hassany, J. Miserez, P. Bielik, L. Vanbever, and M. Vechev: “SDNRacer: concurrency analysis for software-defined networks”, in Proceedings of the 37th ACM SIGPLAN Conference on Programming Language Design and Implementation (PLDI '16). ACM, New York, N.Y., USA, 402-415) do consider the FTE update time in their modelling/simulation (called SDNRacer) of algorithms to check re-routing rules so as to avoid mis-routing (“concurrency violations”), but only by means of allowing configuring of a maximum interval beyond which all necessary FTEs are assumed to be in place ‘based on the maximum network delay and the maximum switch processing time’.

Mizrahi et al. (for reference, see Tal Mizrahi, Efi Saat, and Yoram Moses: “Timed consistent network updates”, in Proceedings of the 1st ACM SIGCOMM Symposium on Software Defined Networking Research (SOSR '15), ACM, New York, N.Y., USA, Article 21) have taken another approach, reviving previous discussions of timestamped-based re-routing, which have been considered impractical in SDN networks, by demonstrating that the tuples used for FTEs, in so-called TCAM memory systems, can be extended by an extra field encoding the time-range when the FTE shall apply. They demonstrate that a synchronous usage of new routing rules (FTEs) can be implemented with an accuracy of less than a microsecond, even in systems with uncertainty of FTE-update-completion. Furthermore, if there is a known bound on the upper limit of FTE installations e.g. even 10 seconds, then the resource consumption introduced by so called TIMEFLIP tuples in the switches can be much reduced (for reference, see Tal Mizrahi, Ori Rottenstreich, and Yoram Moses: “TIMEFLIP: Scheduling Network Updates with Timestamp-based TCAM Ranges”, in Proceedings of the 2015 Conference on Computer Communications, INFOCOM 2015, Kowloon, Hong Kong, April 26-May 1, 2015, pages 2551-2559, in particular section VI.B.: ‘The Cost of High Installation Bounds’).

US 2016/0173378A1 discloses a method to reduce or eliminate potential routing errors due to unavoidable network delays in installing FTEs.

WO 2015/085518 A1 discloses a method to send a FTE update simultaneously with the data packet to be forwarded, hence insuring that the FTE which would be applied for the packed would be exactly the correct one, even if there are significant network or installation delays. However, the inefficiencies (bandwidth, latency) are significant.

### SUMMARY

An embodiment of the present invention provides method operates a software defined network that has a number of data plane elements having flow table entries that define forwarding functions of the data plane elements; and at least one control plane element for programming the forwarding functions of the data plane elements by instructing the data plane elements to install appropriate flow table entries. The method includes: obtaining, by the data plane elements, flow table entry installation time information and making this information available directly or indirectly to the at least one control plane element; and using, by the at least one control plane element, the flow table entry installation time information for deciding on which of the data plane elements to install a particular flow table entry and/or when to transmit an instruction to one or more of the data plane elements to install a particular flow table entry.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view illustrating flow table entry (FTE) installation time sensitive network control in accordance with a first embodiment of the present invention;

FIG. 2 is a schematic view illustrating FTE installation time sensitive network control in accordance with a second embodiment of the present invention;

FIG. 3 is a schematic view illustrating FTE installation time sensitive network control in accordance with a third embodiment of the present invention;

FIG. 4 is a schematic view illustrating an embodiment of the present invention for fast reaction to network events;

FIG. 5 is a schematic view illustrating an embodiment of the present invention for achieving synchronization of FTEs across switches; and

FIG. 6 is a schematic view illustrating an embodiment of the present invention that redirects delay sensitive traffic.

### DETAILED DESCRIPTION

Embodiments of the present invention improve and further develop a software defined network and a method for operating the same in such a way that, by employing means that are readily to implement and operable with low effort, a network controller's capability of making precise and purposeful FTE installation decisions is improved.

In accordance with the invention, an embodiment provides a method for operating a software defined network, the network including a number of data plane elements having flow table entries that define forwarding functions of the data plane elements, and at least one control plane element for programming the forwarding functions of the data plane elements by instructing the data plane elements to install appropriate flow table entries. The method includes obtaining, by the data plane elements, flow table entry installation time information and making this information available directly or indirectly to the at least one control plane element, and using, by the at least one control plane element, the flow table entry installation time information for deciding on which of the data plane elements to install a particular flow table entry and/or when to transmit an instruction to one or more of the data plane elements to install a particular flow table entry.

Furthermore, an embodiment provides a software defined network, including a number of data plane elements having flow table entries that define forwarding functions of the data plane elements, and at least one control plane element for programming the forwarding functions of the data plane elements by instructing the data plane elements to install appropriate flow table entries. The data plane elements are configured to obtain flow table entry installation time information and to make this information available directly or indirectly to the at least one control plane element, and wherein the at least one control plane element is configured to use the flow table entry installation time information for deciding on which of the data plane elements to install a particular flow table entry and/or when to transmit an instruction to one or more of the data plane elements to install a particular flow table entry.

According to embodiments of the invention, it has first been recognized that flow table entry installation times in the data plane elements (in particular network switches) can vary significantly depending on various parameters, such as the current number of flow entries installed, number of flow entries to be installed, and automatic data structure re-organization schedules, just to mention a few reasons. Most of those reasons are internal to the data plane element/switch and very difficult to assess and predict externally. While installation times between 100 milliseconds and 1 second are common, under unfavorable conditions the FTE installation time can reach up to 5 seconds. Such high delays can pose a challenge for network controllers when they (i) need to react quickly to new network events as well as (ii) for maintaining FTEs synchronized across the network (i.e. across several switches). An example for the former would be to select the fastest switch to install a filter for attack traffic. And an example for the latter is to make sure to avoid forwarding loops, detours and errors due to stale FTEs.

In view of the above, the inventors have further recognized that the capability of a control plane element (in particular network controller) of making precise and purposeful FTE installation decisions can be improved by configuring data plane elements, in particular switches, in such a way that they obtain information about their individual flow table installation times and make it exploitable by the network controller, i.e. actively or passively expose this knowledge to the network controller. According to embodiments this may happen either directly via notifications or indirectly through a specification of maximum FTE installation times. The exposed information can then be used by the network controller to make well-informed and thus intelligent decisions on i) where to install a particular flow table entry (i.e. on which switch), and ii) at which time (i.e. when to transmit an instruction to a switch to install a particular flow table entry).

Embodiments of the present invention provide a method for flow installation time sensitive network control that allows addressing the problems of unpredictable FTE installation times. In particular, control plane elements like network controllers can benefit from the provision of FTE installation time information by improving switch selection for FTE installation as well as optimizing the timing of FTE installations across switches.

Another option to address the unpredictability of FTE update/installation includes using a sort of acknowledgement mechanism, e.g. like the one proposed in the OpenFlow Bundles extension that was added in OpenFlow 1.4 (for reference, see OpenFlow® Switch Specification Ver 1.4.1, ONF TS-024, Mar. 26, 2015). However, the problem is that it is very difficult for the OpenFlow Agent (that usually runs as software on a CPU attached to the forwarding pipeline) to know when an FTE change actually gets effective in the pipeline. Thus, according to embodiments of the present invention, either the switch's hardware (HW) helps with the measurement of the installation delay, or the FTE installation deadlines are passed on to the pipeline hardware. In this context, in order to measure FTE installation times, an OpenFlow agent on the switch may be provided with the option to receive notification of an FTE actually having been installed in the forwarding pipeline.

According to an embodiment, the flow table entry installation time information (hereinafter briefly denoted FTE installation time information) obtained by a data plane element may include either the data plane element's current FTE installation time or an estimated upper bound for its current FTE installation time. A data plane element's current FTE installation time may be derived by the data plane element from internal knowledge about the data plane element's architecture and/or the data structure used by the data plane element to store flow tables. Alternatively, a data plane element's current FTE installation time may be determined by means of dedicated measurements performed by the data plane element. According to one embodiment both approaches are carried out in parallel, i.e. the data plane element derives FTE installation time information from internal knowledge and also performs dedicated measurements, and the results of both approaches are combined with each other according to predefined rules, e.g. by calculating a (weighted) average.

According to an embodiment, the dedicated measurements may include the steps of analyzing FTE installation times over a given time period and, based thereupon, determining an average installation time.

According to an embodiment, the flow table entry installation time information may be obtained by a data plane element on a per-flow basis, on a per-flow-table basis or on a per-element basis. Generally, it can be desirable to have the estimates done as granular as possible, i.e. typically it will be better to have per-flow (i.e. combination of same match fields) FTE installation time estimates. Second best option would be to have per-flow-table FTE installation time estimates. Finally, per-switch FTE installation time estimates are also an option.

According to an embodiment, the data plane elements transmit messages containing their FTE installation time information to the at least one control plane element on a regular basis. The time interval can be configured depending on the respective requirements. Alternatively, in order to reduce the signaling overhead, FTE installation time information may be transmitted only in case of changes occurring in their flow table entry installation time information.

According to an embodiment, the control plane element may poll the data plane elements for their flow table entry installation time information.

According to an embodiment, the control plane element may be configured to transmit a request to one or more of the data plane elements to install a flow table entry, where the request specifies a maximum admissible flow table entry installation time for the flow table entry. In turn, the data plane elements may be configured, upon receiving such request, to install the flow table entry only in case installation is possible within the indicated maximum admissible flow table entry installation time. In order to ensure consistent operation, it may be provided that the data plane elements notify the control plane element about success or failure of the installation of the flow table entry.

According to an embodiment, the data plane elements may indicate to the control plane element their capability to obtain and provide flow table entry installation time information, i.e. whether or not they support the feature of providing FTE installation time information.

According to an embodiment, the control plane element may transmit an asynchronous message to a data plane element that instructs the data plane element to start or to stop obtaining and providing flow table entry installation time information. For instance, if the control plane element is in a condition where it does not need any installation time information from particular data plane elements (i.e. where it could not benefit from this information), the control plane element could instruct these data plane elements to stop their measurements, thereby preserving the data plane elements' resources.

There are several ways how to design and further develop the teaching of the present invention in an advantageous way. To this end it is to be referred to the following explanation of preferred embodiments of the invention by way of example. In connection with the explanation of the preferred embodiments of the invention by the aid of the drawings, generally preferred embodiments and further developments of the teaching will be explained.

Since embodiments of the present invention described hereinafter in detail rely on the concepts of Software-Defined Networking (SDN) in combination with the OpenFlow protocol, at first, for ease of understanding, some essential aspects of these concepts will be briefly summarized, while it is generally assumed that those skilled in the art are sufficiently familiar with the respective technologies.

The Software-Defined Networking (SDN) paradigm (as specified in “https://www.opennetworking.org/images/stories/downloads/sdn-resources/

National technical-reports/TR_SDN-ARCH-Overview-1.1-11112014.02.pdf) brings a separation of packet forwarding (data plane) and the control plane functions. In SDN, network elements' forwarding functions (data plane) are programmed by a centralized network controller (control plane). Specifically, network elements, such as switches, routers or the like expose a programming interface towards the network controller to add, modify, and delete entries in the flow tables of these network elements. The flow table entries are used to determine where to forward traffic and what processing steps are applied to the traffic before forwarding it.

Being widely adopted, the OpenFlow protocol provides flow-level abstractions for remote programming of, e.g., a switch's data plane from a centralized controller. This controller instructs an underlying switch with per-flow rules by means of specific ‘flow_mod ’ messages. Such message contains match and action parts with the first specifying the packet headers to match and with the second applying a particular processing decision to all the packets belonging to the specified flow. These forwarding rules are translated into forwarding table statements and become installed as flow table entries (FTEs) into one or several forwarding tables of a table pipeline (for reference, cf. https://www.opennetworking.org/technical-communities/areas/specification).

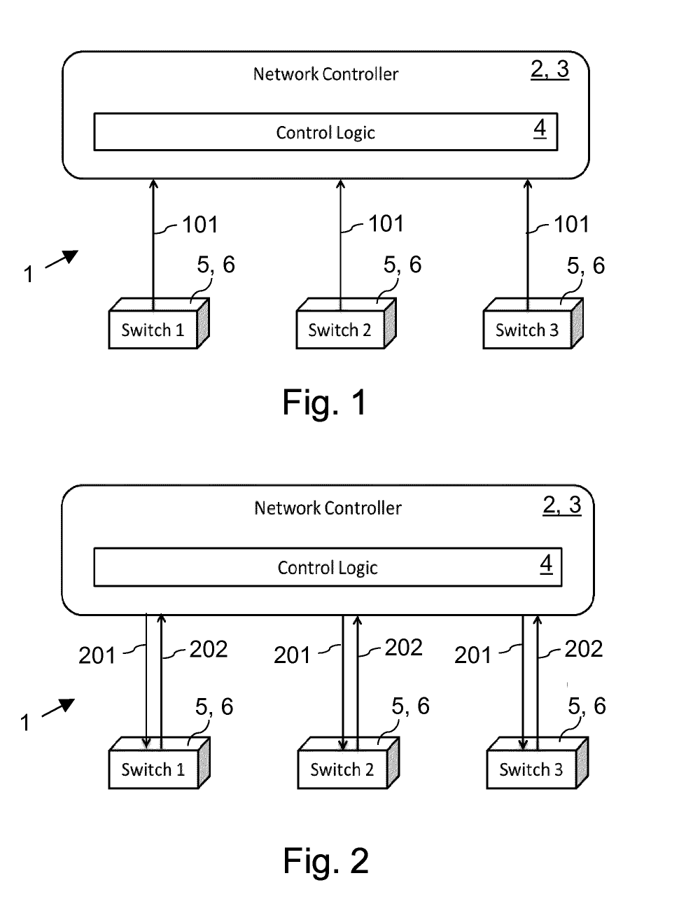

FIG. 1 illustrates an SDN network 1 in accordance with a first embodiment of the present invention. The network 1 includes a control plane element 2 in form of a (centralized) network controller 3 with control logic 4 and a number of data plane elements 5 in form of switches 6. For the sake of simplicity, in FIG. 1 only three switches 6 (denoted switch1, switch2 and switch3) are depicted. However, as will be easily appreciated by those skilled in the art, in practice a single network controller may control a much higher number of network switches.

In accordance with an embodiment of the invention, the switches 6 either track or measure their current individual FTE installation times, or they estimate an upper bound for their FTE installation times. Here, the FTE installation time is defined by the elapsed time between receiving a FTE modification request from the network controller 3 at the respective switch 6 until the time when the corresponding changes to the switch's 6 flow table(s) have been performed.

Next, the FTE installation time information is exposed to the network controller 3. More specifically, as indicated by arrows 101, the switches 6 announce their determined values (i.e. either the measured FTE installation time or the estimated upper bound) to the network controller 3. The control logic 4 of the network controller 3 takes the current FTE installation times into account when deciding where to install certain FTEs (i.e. on which switch) and/or when to issue flow table modification requests.

Examples of scenarios in which such assisted decisions are useful and favorable are described in detail in connection with subsequent FIGS. 4-6.

As already mentioned above, the FTE installation time information obtained by a switch 6 may include the current individual FTE installation time evaluated by the respective switch 6. A switch 6 may evaluate its current FTE installation time in different ways. For instance, a switch 6 may execute dedicated measurements as follows:

In both cases of HW (hardware) and SW (software) switches, a switch 6 can analyze its last FTE installation times by specifying time windows and by measuring the values of the last time window (e.g., last 2 minutes). Based on the values of the last time window, the switch 6 can determine expected FTE installation times for a current time window. For instance, if during the last two minutes the switch 6 has installed all the FTEs within 20 sec or less, this value can be considered as an expected upper bound for the switch's 6 actual FTE installation time, considering the current switch load. The switch 6 can give this value to the controller 3 as an indicator (e.g., estimated upper bound) of the FTE installation time with the current switch condition (e.g., load). In particular, in a software switch, e.g. OVS (Open vSwitch), one could generate timestamps and store them in meta-data related to the respective flow table modification request (i.e. flow_mod in case of OpenFlow) from the network controller 3. For the reporting, the switch 6 could keep the most recently measured FTE installation time, either for the whole switch 6 or per flow table.

However, the above solution might not be very accurate since the FTE installation time depends on several factors, thus the average of a certain period of time is just an indicator rather than a threshold. In order to improve results, a switch 6 may evaluate its current FTE installation time by making use of internal knowledge about the switch architecture (e.g., hardware or software) and/or the data structure used to store the forwarding rules. More in general, the FTE installation time in a switch (e.g., HW, SW) may be assumed to be composed by 2 components as follows:

FTE installation time=fix component (FIX)+variable component (VAR)

The Fix Component (FIX) specifies the time needed to install a rule in the table (e.g., HW, SW), independently from the other factors. Technically, it is the time needed to install a single rule under best conditions of the switch (e.g., data structure completely empty). To evaluate this component, a deeper knowledge about the internal switch architecture is required. For instance, in case of a HW switch, the FTE installation time (fix component) may be determined by the TCAM characteristics used. On the other hand, in case of a SW switch (e.g., OVS), the FTE installation time (fix component) depends on several factors, such as CPU speed, RAM speed, or the like.

The Variable Component (VAR) is the additional time needed in order to complete the insertion into the data structure and it depends on several factors, such as the type of a flow table modification request. In this context it is important to determine, for instance, what are the match fields, does the request contain any wildcard matches, etc. Other factors include, but not limited to, the number of rules already installed in the switch and the re-balancing algorithm used in order to keep some properties for the data structure. For instance, with respect to the number of rules already installed in the switch, installing a rule in an empty flow table will typically be faster than installing a rule in a flow table that already contains a significant amount of entries.

The embodiment of FIG. 1 can be realized by employing, e.g., the OpenFlow protocol (as specified in “OpenFlow Switch Specification”, Version 1.3.5, Open Network Foundation, ONF TS-023, Mar. 26, 2015). In this case, the OpenFlow protocol may be extended by specifying a new feature, which is a FTE installation time notification feature (briefly denoted hereinafter FTE-IT-Not). The availability or support of this FTE-IT-Not feature could be indicated as a switch's 6 capability. This means that in case a switch 6 is configured to support the FTE-IT-Not feature (i.e. the switch 6 is capable of obtaining FTE installation time information and making this information available directly or indirectly to the network controller 3), the switch 6 is characterized as an FTE-IT-Not capable switch 6.

According to an embodiment a further extension of the OpenFlow protocol is implemented, which consists in an asynchronous controller-to-switch message that allows turning on and off FTE-IT-Not. This means that when the network controller 3 wishes to receive FTE installation time information from a particular switch 6 under its control, the network controller 3 sends this message to the respective switch 6. Upon receipt, at the switch 6 the FTE-IT-Not feature will be activated or turned on, which means that the switch 6 starts obtaining and reporting FTE installation time information. In addition, the message may be configured to not only allow turning on/off FTE-IT-Not, but to also customize certain configuration parameters of FTE-IT-Not, such as the reporting interval and granularity.

Still another extension of the OpenFlow protocol consists in an implementation of an asynchronous switch-to-controller message (corresponding to the message denoted 101 in FIG. 1) that is used by a switch 6 to report the current FTE installation times, either from measurements or as an upper bound estimate, to the network controller 3. Ideally, this reporting is done in a per table granularity, as FTE installation times may vary depending on the complexity of the supported features per table.

For instance, in the embodiment of FIG. 1, when the FTE-IT-Not feature is turned on by the network controller 3 at a particular switch 6, the switch's 6 reporting messages may be sent periodically to the network controller 3. If it is turned off or periodic transmission is not supported, the network controller 3 can explicitly request (e.g. poll) the FTE installation time information from the switch 6. Alternatively, the switch 6 may be configured to only report to the network controller 3 when its FTE installation time measurement or estimate changes or when the change exceeds a predefined tolerance range.

FIG. 2, wherein like reference numerals denote like components as in FIG. 1, illustrates an SDN network 1 in accordance with another embodiment of the present invention. Instead of having the switches 6 explicitly transmitting the current FTE installation times to the network controller 3, as described above in connection with the embodiment of FIG. 1, the embodiment of FIG. 2 implements an indirect notification mechanism.

Like in the embodiment of FIG. 1, also in the embodiment of FIG. 2 the switches 6 measure their current FTE installation time or estimate an upper bound for it. Again, the FTE installation time is defined by the elapsed time between receiving a FTE modification request from the network controller 3 at the respective switch 6 until the time when the corresponding changes to the switch's 6 flow table(s) have been performed.

Next, as indicated by arrows 201, when the network controller 3 transmits a request to a switch 6 to install a particular FTE, this request also contains a target installation time, i.e. a maximum admissible installation time. That is, if the respective FTE cannot be installed by the switch 6 within the specified maximum installation time, the FTE will not be installed. In case of the OpenFlow protocol, this procedure could be implemented by using modified flow mod messages that are extended to include the maximum admissible installation time.

As indicated by arrows 202, the switches 6 notify the network controller 3 about the success or failure of FTE installation. According to an embodiment this notification may also be employed by the switches 6 to announce their current FTE installation time to the network controller 3.

The embodiment of FIG. 2 can also be realized by employing the OpenFlow protocol. In this case, the OpenFlow protocol may be modified by replacing the asynchronous regular flow mod message from the network controller 3 to a switch 6 with a synchronous pair of flow mod messages where the controller-to-switch message allows the specification of a maximum installation time or a deadline until when the FTE has to be installed, and where the switch-to-controller message indicates if the FTE was installed or not. Additionally, this message might include the current FTE installation time. The same as above could be achieved by implementing, instead of a synchronous pair of flow mod messages, two asynchronous messages, which will then need IDs for the purpose of matching them together on the controller side.

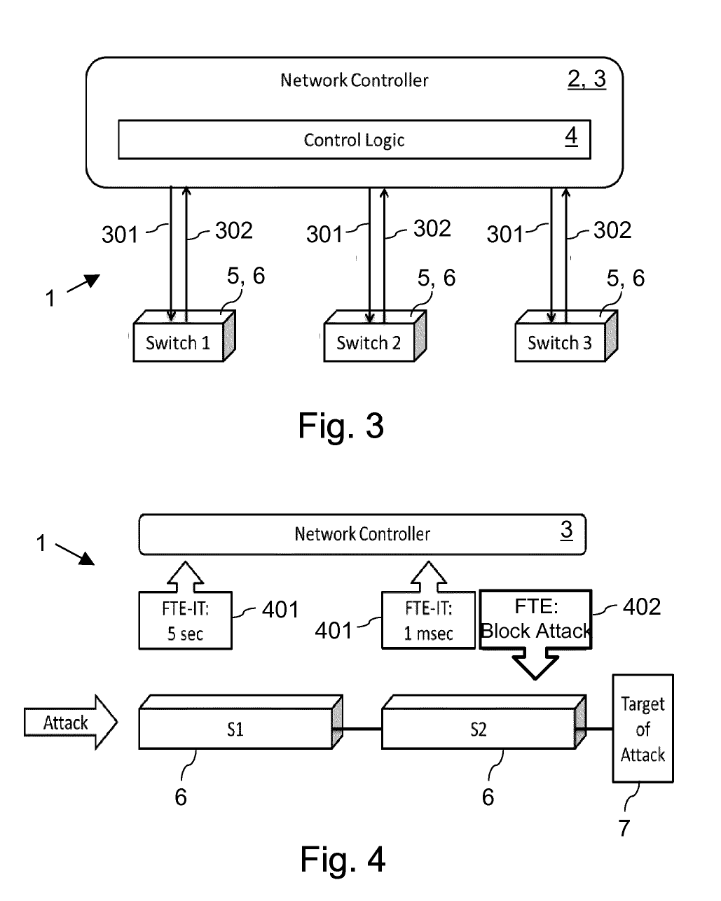

Turning now to FIG. 3, this figure illustrates an SDN network 1 in accordance with still another embodiment of the present invention, wherein a polling notification scheme is implemented, alternatively to two previous methods of exposing FTE installation time information to the network controller 3.

Like in the embodiments of FIGS. 1 and 2, also in the embodiment of FIG. 3 the switches 6 measure their current FTE installation time or estimate an upper bound for it. Again, the FTE installation time is defined by the elapsed time between receiving a FTE modification request from the network controller 3 at the respective switch 6 until the time when the corresponding changes to the switch's 6 flow table(s) have been performed.

Next, as indicated by arrows 301, the network controller 3 polls the switches 6 for their FTE installation time information. In reaction to being polled, the switches 6 send their FTE installation time information, e.g. their current measured FTE installation times, to the network controller 3, as indicated by arrows 302. The network controller 3 takes the received FTE installation time information into account when deciding where (i.e. at which switch) to install certain FTEs and when to issue flow table modification requests. Example scenarios for such decision making are described hereinafter in connection with FIGS. 4-6.

In the case of using the OpenFlow protocol in connection with the embodiment of FIG. 3, the OpenFlow protocol may be modified by introducing a new controller-to-switch message requesting/polling, by the network controller 3, FTE installation time information from the switches 6, as well as a reply message reporting respective installation information/times back to the requesting controller 3.

One example of how the control logic 4 of the network controller 3 could take advantage of the knowledge about FTE installation times is when it is necessary to quickly react to certain network events. For instance, assuming a topology as show in FIG. 4, where Attack traffic directed to a target of attack 7 is traversing the two switches 6 denoted Si and S2. In order to mitigate the attack the network controller 3 needs to program a flow table entry that blocks the attack traffic.

In principle, it is advisable to block the traffic as close to the source as possible, i.e. at S1 in the illustrated embodiment. However, when assuming FTE installation times (FTE-IT), either measured values or estimated upper bounds, of 5 sec on S1 versus 1 msec on S2 (the respective notifications as transmitted from the switches 6 to network controller 3 are indicated at 401), it would be much better to use S2 in this scenario. Therefore, by using the respective FTE installation time information transmitted to the network controller 3 from the switches 6, the network controller 3 decides to install a FTE that is appropriate to block the attack traffic on S2 instead of S1, as indicated at 402. In that way, by applying the present invention it is possible to avoid almost 5 sec of attack traffic arriving at its target 7.

Other scenarios, where knowledge about FTE installation times is useful, include failure of network components or network links as well as path relocation due to changed conditions, for instance, changed network loads, path requirements or customers. In such scenarios, in order to lose as few data packets as possible, the network controller can compute an ideal order in which it will delete old and install new FTEs in the different switches. This then makes sure that the rules are installed when the traffic arrives and minimizes loss and delays in packet delivery. The knowledge about the FTE installation times could result in a different order than the simple knowledge of the path itself, since a switch closer to the source could take longer in installing the FTE than one that is farther away and thus would cause packet loss.

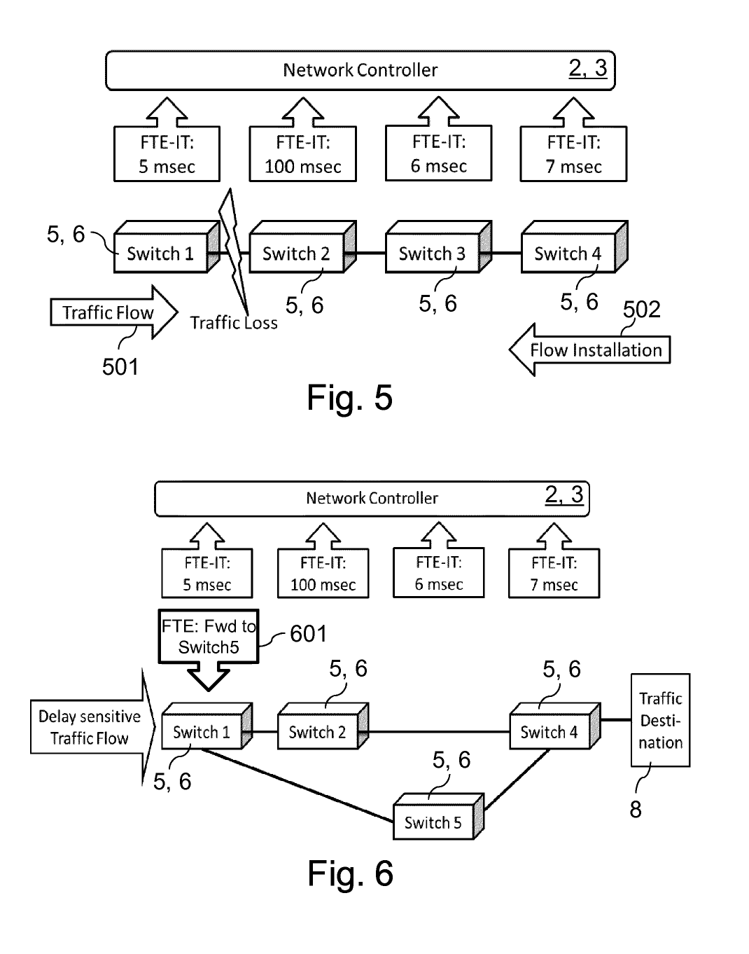

FIG. 5, in which like reference numerals again denote like components as in the previous figures, exemplarily illustrates an application scenario of an embodiment of the present invention, where the control logic 4 of the network controller 3 can take advantage of the knowledge about FTE installation times in order to achieve synchronization of FTEs across the switches 6. Specifically, as indicated at 501, a traffic flow is assumed to pass, on its path to its destination, the switches 6 in the order Switch1, Switch2, Switch3 and Switch4. Commonly, in such case it would be best practice to carry out FTE installation for this traffic flow in the opposite direction, i.e. starting with Switch4, continuing with Switch3 and so forth, as indicated at 502. By doing so, situations will be avoided in which the traffic flow arrives at a switch 6 that has not yet installed any FTEs for this traffic flow.

However, applying the above common practice to the scenario illustrated in FIG. 5, in which one of the switches 6, Switch2, has a much longer FTE installation time then the other switches 6 (100 msec compared to 5-7 msec), would cause traffic loss between Switch1 and Switch2. Therefore, in accordance with an embodiment of the present invention, the network controller 3 may decide, by making use of the FTE installation time information made available by the switches 6, to bring forward FTE installation on Switch2, thereby minimizing losses and delays of the traffic flow.

Turning now to FIG. 6, this figure exemplarily illustrates still another application scenario of an embodiment of the present invention, where the control logic 4 (not shown) of the network controller 3 is confronted with the challenge to redirect or detour delay sensitive traffic.

In connection with this embodiment it is assumed that a SLA (Service Level Agreement) is in place according to which a budget of 50 msec is allowed to forward certain traffic. It is further assumed to have a network topology as shown in FIG. 6. Usually, a path to the destination 8 along Switch1→Switch2→Switch4 would be the preferable one, since it is more cost effective to utilize than a path, e.g., via Switch5 (which can be assumed in the illustrated example, when considering the graph edges length as the corresponding network cost). However, in this example the existing SLA could not be fulfilled, since a FTE in Switch2 cannot be installed fast enough (the installation would take 100 msec, while only 50 msec are allowed). Knowing about the FTE installation times or utilizing installation time deadlines, the network controller 3 can avoid the long installation time on Switch2 and can use Switch5 instead by installing an appropriate FTE at Switchl, as indicated at 601. It is worth mentioning that without the present invention in place, the network controller 3 would not even be aware of the problem, and try to setup the path via Switch2, thereby causing either that the packets will be dropped or the SLA will be violated.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for operating a software defined network, the software defined network including:
a number of data plane elements having flow table entries that define forwarding functions of the data plane elements; and
at least one control plane element for programming the forwarding functions of the data plane elements by instructing the data plane elements to install appropriate flow table entries,
the method comprising:
obtaining, by the data plane elements, flow table entry installation time information and making this information available directly or indirectly to the at least one control plane element; and
using, by the at least one control plane element, the flow table entry installation time information for deciding on which of the data plane elements to install a particular flow table entry and/or when to transmit an instruction to one or more of the data plane elements to install a particular flow table entry.

2. The method according to claim 1, wherein the flow table entry installation time information obtained by a data plane element of the data plane elements includes the data plane element's current flow table entry installation time or an estimated upper bound for its current flow table entry installation time.

3. The method according to claim 1, wherein a current flow table entry installation time of a data plane element of the data plane elements is derived by the data plane element from internal knowledge about the data plane element's architecture and/or the data structure used by the data plane element to store flow tables.

4. The method according to claim 1, wherein a current flow table entry installation time of a data plane element of the data plane elements is determined via dedicated measurements performed by the data plane element.

5. The method according to claim 4, wherein the dedicated measurements include the step of:
analyzing flow table entry installation times over a given time period; and
based thereupon, determining an average installation time.

6. The method according to claim 1, wherein the flow table entry installation time information is obtained by a data plane element of the data plane elements on a per-flow basis, on a per-flow-table basis, or on a per-element basis.

7. The method according to claim 1, wherein the data plane elements transmit messages containing their flow table entry installation time information to the at least one control plane element either on a regular basis or in case of changes occurring in their flow table entry installation time information.

8. The method according to claim 1, wherein the at least one control plane element polls the data plane elements for their flow table entry installation time information.

9. The method according to claim 1, comprising:
transmitting, by the at least one control plane element, a request to one or more of the data plane elements to install a flow table entry, the request specifying a maximum admissible flow table entry installation time for the flow table entry; and
installing, by the data plane elements), the flow table entry only in case installation is possible within the maximum admissible flow table entry installation time.

10. The method according to claim 9, wherein the data plane elements notify the at least one control plane element about success or failure of the installation of the flow table entry.

11. The method according to claim 1, wherein the data plane elements indicate to the at least one control plane element their capability to obtain and provide flow table entry installation time information.

12. The method according to claim 1, comprising:
transmitting, by the at least one control plane element, an asynchronous message to a data plane element that instructs the data plane element to start or to stop obtaining and providing flow table entry installation time information.

13. A software defined network comprising:
a number of data plane elements having flow table entries that define forwarding functions of the data plane elements; and
at least one control plane element for programming the forwarding functions of the data plane elements by instructing the data plane elements to install appropriate flow table entries,
wherein the data plane elements are configured to obtain flow table entry installation time information and to make this information available directly or indirectly to the at least one control plane element, and
wherein the at least one control plane element is configured to use the flow table entry installation time information for deciding on which of the data plane elements to install a particular flow table entry and/or when to transmit an instruction to one or more of the data plane elements to install a particular flow table entry.

14. A data plane element, configured for being employed in a method according to claim 1.

15. A control plane element configured for being employed in a method according to claim 1.
